(19) United States
(12) Patent Application Publication
(10) Pub. No.: US 2024/0191710 A1
(43) Pub. Date: Jun. 13, 2024

(54) COATING FOR REDUCING FRICTION IN A RECIPROCATING ASSEMBLY

(71) Applicant: Hubbell Incorporated, Shelton, CT (US)

(72) Inventors: Cody McCarthy, Strafford, NH (US); John Lefavour, Litchfield, NH (US); Robert Auger, Merrimack, NH (US)

(21) Appl. No.: 18/506,418

(22) Filed: Nov. 10, 2023

Related U.S. Application Data
(60) Provisional application No. 63/431,423, filed on Dec. 9, 2022.

(51) Int. Cl. F04B 53/18; F04B 53/10; F04B 53/14

(52) U.S. Cl. CPC F04B 53/18; F04B 53/10; F04B 53/14

(57) ABSTRACT

A reciprocating assembly for driving a working portion of a tool includes a body having a bore configured to contain a hydraulic fluid, and a piston received within the bore and configured to move within the bore in a reciprocating motion between an extended position and a retracted position. Displacement of the piston within the bore is configured to cause displacement of hydraulic fluid when hydraulic fluid is in the bore. An outer surface of the piston and/or an inner surface of the bore at least partially coated with a friction reducing material.

### CROSS-REFERENCE TO RELATED APPLICATION

This application claims priority to U.S. Provisional Patent Application No. 63/431,423, filed Dec. 9, 2022, the entire contents of which is incorporated herein by reference in its entirety.

### FIELD

The present disclosure relates to coatings for reducing frictional wear. More particularly, the present disclosure relates to a reciprocating assembly that includes a coating to reduce frictional wear between different engaging elements.

### BACKGROUND

Reciprocating assemblies, like gas engines, hydraulic pumps, and pneumatic cylinders among other things, utilize one or more pistons to move a working fluid (e.g., gasoline, oil, air, etc.). The piston is received within a cylinder and moves back and forth in a reciprocating motion. In a retracted position, the working fluid may fill the cylinder. In an extended position, the piston may push the working fluid out of the cylinder.

Movement of the piston within the cylinder causes abrasiveness or frictional engagement between these two surfaces as the piston is repeatedly moved relative to the surface of the cylinder. This repeated engagement while the assembly is in use creates wear on one or both of the contact surfaces. This wear may lead to lower efficiencies in the assembly and/or failure in the assembly.

This frictional contact can also occur in other parts of the assembly, for example along any adjacent surfaces where relative motion occurs. These surfaces may similarly experience frictional wear, and lead to lower efficiencies and/or failure of the elements.

Another example of this may occur in a gear assembly. For example, in a planetary gear arrangement, a planet gear may spin and rotate in use. Unwanted friction may be an issue when a planet gear is spinning about the respective carrier shaft. This friction makes it harder for the planet gears to rotate, which necessitates that the motor increase its output to achieve the desired output in the carrier. Accordingly, the motor may need to run at higher currents, which over time will lead to failure in the motor.

Still another example of this may occur in valve assemblies. For example, a tool may include a drain pin disposed proximate to a pump to assist in draining fluid. Like other components in the tool, the drain pin may move in a reciprocating motion to selectively allow and limit draining at various points in the reciprocating cycle. As the drain pin moves, it can rub against another surface, which can create surface scratching. Similarly, a valve may rub against another surface as it moves, which may similarly cause surface scratching. The scratching and other wear marks may decrease efficiency and/or increase the rate of failure within the tool.

This frictional wear may be especially problematic when one or both elements in contact with one another are constructed from an “abrasive” material. For example, aluminum may be used to construct at least some of the elements in reciprocating assemblies because it is light weight. However, aluminum is also abrasive. Reciprocating engagement with an aluminum element can accelerate the frictional wear. For example, repeated rubbing between an aluminum surface and a steel surface can create scratching in the steel surface as a result. The abrasive nature of an aluminum surface can also cause scratching to occur on other surfaces, like the elastomeric surface of an O-ring. The scratching can increase the likelihood of leaks, which can decrease efficiency and/or cause failure in the tool.

In addition to elements simply rubbing against one another, the process driving the reciprocating movement may produce an undesirable radial load in addition to the desired axial load. For example, in addition to a piston being driven axially within a cylinder, the piston may also be driven radially into the wall of the cylinder because of the movement of the reciprocating assembly. The radial directed load can cause additional abrasiveness and further accelerate wear.

### SUMMARY

Various embodiments of the present disclosure can overcome various of the aforementioned and other disadvantages associated with known reciprocating assemblies and offer new advantages as well.

According to one aspect of various embodiments of the present disclosure there is provided a reciprocating assembly that includes a first surface and a second surface in contact with and movable relative to the second surface. At least one of the first surface and the second surface includes a coating configured to reduce abrasiveness.

According to another aspect of various embodiments of the present disclosure, there is provided a first element and a second element that moves relative to the first element. At least one of the first element and the second element includes a coating configured to reduce abrasiveness caused by the relative movement.

According to another aspect of various embodiments of the present disclosure, there is provided a cylinder and a piston movable relative to the cylinder, wherein at least one of the cylinder and the piston is at least partially coated with a friction reducing material.

According to another aspect of various embodiments of the present disclosure, there is provided a gear assembly including a carrier shaft and a planet gear configured to rotate around the carrier shaft, wherein at least one of the carrier shaft and the planet gear is at least partially coated with a friction reducing material.

According to another aspect of various embodiments of the present disclosure, there is provided a gear assembly including a ring gear and a planet gear configured to move relative to the ring gear, wherein at least one of the ring gear and the planet gear is at least partially coated with a friction reducing material.

According to another aspect of various embodiments of the present disclosure, there is provided a valve assembly including a passageway and a valve configured to move relative to the passageway, wherein at least one of the valve and the passageway is at least partially coated with a friction reducing material.

According to another aspect of various embodiments of the present disclosure, there is provided a first surface constructed from aluminum and a second surface constructed from steel, wherein at least one of the first surface and the second surface is configured to move relative to and contact the other of the at least one first surface and the second surface, and wherein at least one of the first surface and the second surface is at least partially coated with a friction reducing material.

According to another aspect of various embodiments of the present disclosure, there is provided a movable element that is at least partially coated with a diamond like carbon (DLC) coating that is configured to reduce abrasiveness as the movable part contacts another element.

According to another aspect of various embodiments of the present disclosure, there is provided a stationary element that is at least partially coated with a DLC coating that is configured to reduce abrasiveness as a movable part contacts the stationary element.

According to another aspect of various embodiments of the present disclosure, there is provided a reciprocating assembly for driving a working portion of a tool. The reciprocating assembly includes a body having a bore configured to contain a hydraulic fluid, and a piston received within the bore and configured to move within the bore in a reciprocating motion between an extended position and a retracted position. Displacement of the piston within the bore is configured to cause displacement of hydraulic fluid when hydraulic fluid is in the bore. An outer surface of the piston and/or an inner surface of the bore at least partially coated with a friction reducing material.

According to another aspect of various embodiments of the present disclosure, there is provided a reciprocating assembly for driving a working portion of a tool. The reciprocating assembly includes a stationary element constructed from a first material and a movable element constructed from a second material. The first material is more abrasive than the second material. A friction-reducing coating is applied to the first material and can reduce abrasion on the second material as it contacts the first material.

In some forms, a) the first material is different than the second material; b) the first material is aluminum and the second material is steel; and/or c) the stationary element is a bore and the movable element is a piston received within the bore.

In some forms, a) the entire surface of the stationary element is coated with the DLC coating; and/or b) the entire surface of the movable element is coated with the DLC coating.

According to another aspect of various embodiments of the present disclosure, there is provided a method for preventing wear on a reciprocating assembly, the method includes applying a coating to at least one of a first surface and a second surface of the reciprocating assembly, wherein the first surface and the second surface are movable relative to one another.

According to another aspect of various embodiments of the present disclosure, there is provided a method of applying a diamond like carbon (DLC) coating to a first surface; and moving the first surface relative to a second surface within a reciprocating assembly; wherein the DCL coating limits abrasion between the first surface and the second surface.

According to another aspect of various embodiments of the present disclosure, there is provided a method of constructing a reciprocating assembly. The method can include applying a diamond like carbon (DLC) coating to a first element constructed from a first material; connecting the first element to a second element constructed from a second material; and moving the first element and the second element relative to one another. The first material may be different than the second material.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 shows a tool according to an exemplary example of the disclosure.

FIG. 2 shows a cross-sectional view of the tool of FIG. 1, illustrating a gear assembly.

FIG. 3 shows a cross-sectional view of the tool of FIG. 1, illustrating a pump body and a pump sleeve.

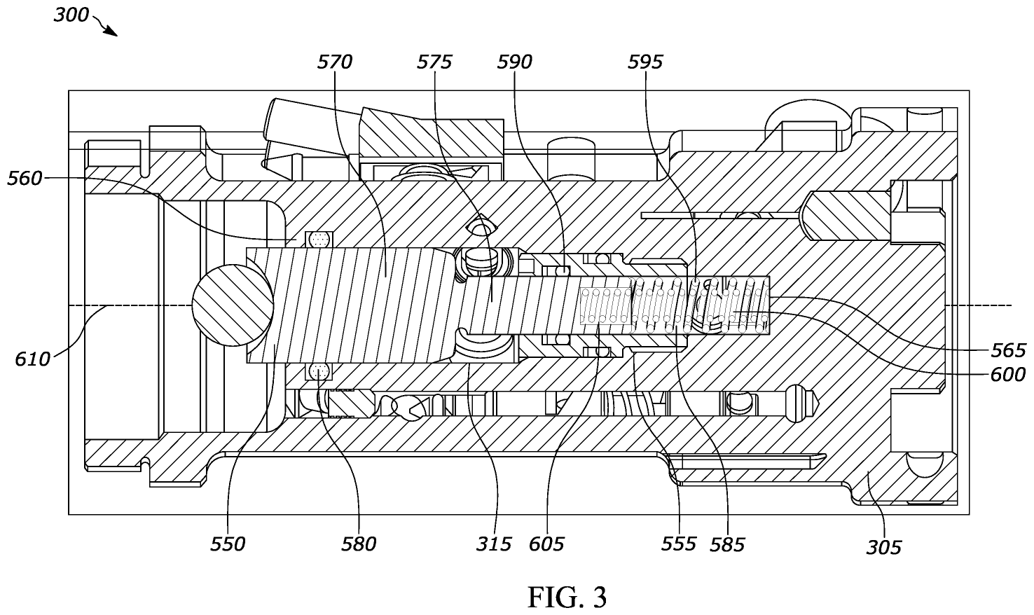

FIG. 4 shows a cross-sectional view of the tool of FIG. 1, illustrating a drain pin in the pump body.

FIG. 5 shows a cross-sectional view of the tool of FIG. 1, illustrating a piston and a cylinder.

### DETAILED DESCRIPTION

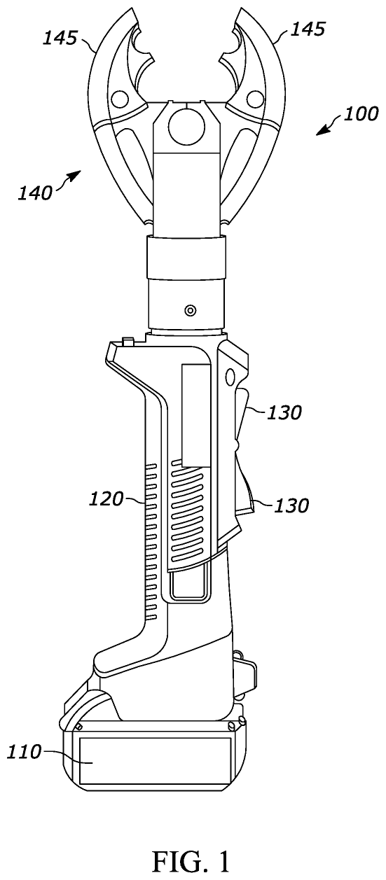

FIG. 1 illustrates a tool 100. The illustrated tool 100 is a handheld power tool, which allows the tool 100 to be portably used at different work sites. The tool 100 may be powered by a rechargeable battery 110. This type of battery 110 may be interchanged with other types of power tools.

The tool 100 includes an elongated body 120 that a user grips while using the tool 100. The elongated body 120 includes one or more controls 130 (e.g., two shown) for operating the tool 100. The battery 110 is removably connected to the one end of the body 120.

The illustrated tool 100 includes a working portion 140 connecting to an opposite end of the elongated body 120 from the battery 110. The illustrated working portion 140 is configured for performing a crimping or cutting function. The working portion 140 includes a pair of jaws 145 that move relative to one another to cut or crimp a piece of material.

The illustrated tool 100 may be a hydraulic tool (e.g., an in-line hydraulic tool). As will be described in more detail below, the electrical energy from the battery 110 may be used to drive a hydraulic fluid, that in turn drives the working portion 140.

The tool 100 may include a motor (e.g., a brushed or brushless DC motor—not shown). The motor may be electrically connected to the battery 110 when the battery 110 is connected to the body 120. When the tool 100 is powered on, current from the battery 110 may drive operation of the motor.

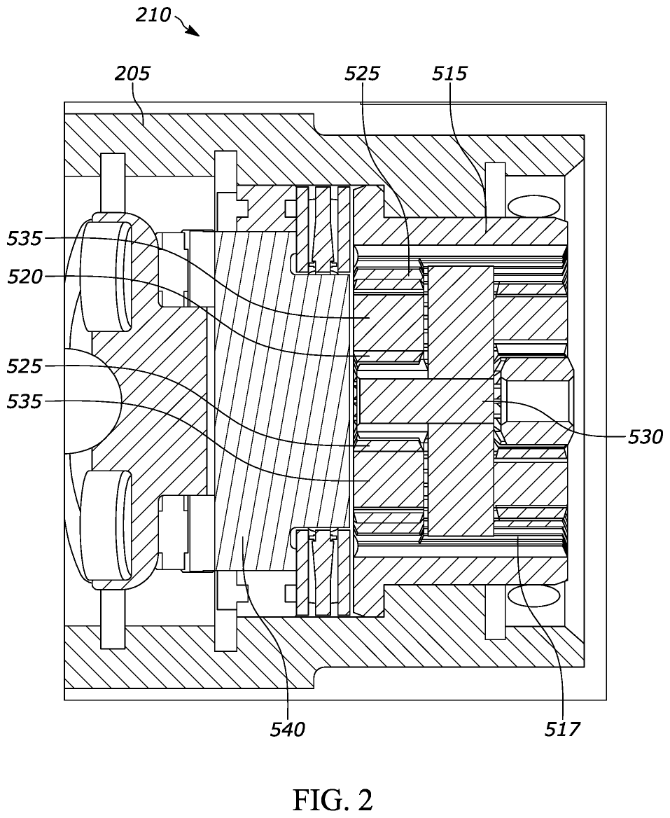

As shown in FIG. 2, the tool 100 may include a gear assembly 210 that is received within a housing 205 and that is connected to the motor. Rotation of the motor 200 may drive the rotation of the gear assembly 210.

In the illustrated example, the gear assembly 210 may be a planetary gear assembly that operates as a multi-stage gear system. The planetary gear assembly 210 includes a ring gear 515, which may have a generally circular shape with an outer surface in contact with the housing 205. The inner surface of the ring gear 515 includes a plurality of teeth 517. Within the ring gear 515 is positioned a sun gear 520 and one or more planet gears 525. The illustrated cross-section shows two planet gears 525, although any number of planet gears 525 may be used. The sun gear 520 may be positioned at approximately the center of the ring gear 515. The sun gear 520 has teeth on its outer surface that face, but are spaced apart from, the teeth 517 of the ring gear 515. Each planet gear 525 is positioned between the sun gear 520 and the ring gear 515. For example, the planet gear 525 includes teeth on its outer surface that are in contact with the teeth 517 of the ring gear 515 and the teeth of the sun gear 520.

In some forms, the ring gear 515 may be a non-rotational gear, although in other examples the ring gear 515 may rotate (e.g., and the sun gear 520 remains stationary).

The sun gear 520 is driven by a drive shaft 530, which may be connected to a center of the sun gear 520. Carrier shafts 535 are connected to a center of each of the planet gears 525. The carrier shafts 535 are each connected to a carrier 540, which provides the output from the gear assembly 210.

In use, the planet gears 525 rotate around the sun gear 520 while also spinning around the respective carrier shaft 535. To reduce unwanted friction between each sun gear 520 and respective carrier shaft 535, either or both elements may be coated with a material that reduces friction.

For example, an inner surface of each planet gear 525 (e.g., the surface in contact with the respective carrier shaft 535) may be at least partially coated (e.g., at least 25% of the surface is coated, at least 50% of the surface is coated, the entire surface is coated, etc.) with a material that reduces friction. In other examples, the outer surface of each carrier shaft 535 (e.g., the surface in contact with the respective planet gear 525) may be at least partially coated (e.g., at least 25% of the surface is coated, at least 50% of the surface is coated, the entire surface is coated, etc.) with a material that reduces friction. In still other examples, the inner surface of each planet gear 525 and the outer surface of each carrier shaft 535 may be at least partially coated (e.g., at least 25% of the surface is coated, at least 50% of the surface is coated, the entire surface is coated, etc.) with a material that reduces friction.

In still other examples, an inner surface of the sun gear 520 (e.g., the surface in contact with the drive shaft 530) may be at least partially coated (e.g., at least 25% of the surface is coated, at least 50% of the surface is coated, the entire surface is coated, etc.) with a material that reduces friction. In other examples, the outer surface of the drive shaft 530 (e.g., the surface in contact with the sun gear 520) may be at least partially coated (e.g., at least 25% of the surface is coated, at least 50% of the surface is coated, the entire surface is coated) with a material that reduces friction. In still other examples, the inner surface of the sun gear 520 and the outer surface of the drive shaft 530 may be at least partially coated (e.g., at least 25% of the surface is coated, at least 50% of the surface is coated, the entire surface is coated) with a material that reduces friction.

In other examples, the outer surface of one of more of the ring gear 515, sun gear 520, and planet gears 525 may be at least partially coated (e.g., at least 25% of the surface is coated, at least 50% of the surface is coated, the entire surface is coated, etc.) with a material that reduces friction.

In any of these examples, a surface may have less than 100% coating if less than all the surface contacts another surface during operation of the tool, which may save coating costs. However, portions of a surface not in contact with another surface may be coated to simplify manufacturing.

In some forms, the material that reduces friction may be a diamond like carbon (DLC) coating that is applied to any one of the above-mentioned surfaces. The DLC coating allows the planet gears 525 to rotate on the respective carrier shaft 535 and or the sun gear 520 to rotate on the drive shaft 530 with less frictional engagement. Additionally, the DLC coating allows the sun gear 520 and the planet gears 525 to rotate relative to one another and the ring gear 515 with less frictional engagement. The DLC coating also minimizes the electrical current requirements needed by the motor to produce the necessary output torque in the carrier 540. Thus, the DLC coating may make the gear assembly 210 more efficient (e.g., less electrical energy from the battery 110 is required to achieve the desired output).

In other examples (not shown), the gear assembly 210 may be a one-stage gear assembly with a pinion gear disposed at the center of the ring gear 515 in place of a sun gear 520. The pinion gear may be connected directly to the motor and may be positioned between at least one planet gear 525 and the ring gear 515. The pinion gear may be similarly coated with the DLC coating to similarly reduce friction and minimize electrical current requirements.

The gear assembly 210 may be used to drive a hydraulic assembly 300. As will be described in more detail below, the hydraulic assembly 300 includes pistons for driving a working fluid that ultimately drives operation of the working portion 140.

The hydraulic assembly 300 includes a housing or pump body 305, which includes a bore 315, which may contain hydraulic fluid during operation of the tool 100. A reciprocating pump 550 and a pump sleeve 555 are disposed within the bore 315 of the pump body 305. As will be described in more detail below, the reciprocating pump 550 may be movable relative to the pump sleeve 555 and the bore 315 during operation of the tool 100.

The pump body 305 may be constructed from aluminum, although any similar material may be used. Aluminum may make the pump body 305 light weight and therefore easier for a user to handle the tool 100. The reciprocating pump 550 and/or the pump sleeve 555 may be constructed from steel, although any similar material may be used.

In the illustrated example, the bore 315 may include an opened first end 560 and a closed second end 565 opposite to the first end 560. The pump sleeve 555 is disposed in the bore 315 proximate to the second end 565, and the reciprocating pump 550 is disposed within the bore 315 at least partially between the first end 560 and the pump sleeve 555. For example, at least a portion of the reciprocating pump 550 may extend beyond the first end 560 (e.g., in a direction away from the second end 565) and/or at least a portion of the reciprocating pump 550 may extend within the pump sleeve 555.

The reciprocating pump 550 may include a first section 570 and a second section 575, with the first section 570 being larger than the second section 575. In the illustrated example, the reciprocating pump 550 includes a stepped transition between the first section 570 and the second section 575, although in other examples, there may be a smooth transition between the first and second sections 570, 575.

The width of the first section 570 may substantially correspond to the width of the bore 315 proximate to the first end 560. An O-ring 580 may be disposed in the bore 315 proximate to the first end 560. The O-ring 580 may assist in limiting leaks from the bore 315 through the first end 560.

The width of the bore 315 may narrow toward the second end 565. The outer width of the pump sleeve 555 may be narrower than the width of the bore 315 proximate to the first end 560. Additionally, an inner width of the pump sleeve 555 (e.g., with a passageway 585 of the pump sleeve 555) may be further narrower than the width of the bore 315 proximate to the first end 560. This inner width of the pump sleeve 555 may be approximately the same size as the outer width of the second section 575. An O-ring 590 is disposed within the passageway 585 and may contact the second section 575 to limit leaks in the passageway 585.

In the illustrated example, a first spring 595 and a second spring 600 are positioned within the bore 315 proximate to the second end 565 (although any number of springs may be used). The first spring 595 may be wider and may extend between the second end 565 of the bore 315 and the end of the second section 575 of the reciprocating pump 550. The second spring 600 may extend between the second end 565 of the bore 315 and a cavity 605 in the second section 575 that is recessed from the end of the second section 575. The second spring 600 may therefore be longer than the first spring 595.

In some forms, the second spring 600 may be disposed within the first spring 595 so that the first and second springs 595, 600 are in parallel with one another.

The pump sleeve 555 may be open at both ends. In other words, passageway 585 is open at both ends. The first and second springs 595, 600 may extend into the passageway 585 through one end and the second section 575 of the reciprocating pump 550 may extend into the passageway 585 through the other end. Movement of the second section 575 within the passageway 585 affects the length of the springs 595, 600. For example, movement of the reciprocating pump 550 toward the second end 565 of the bore 315 compresses the springs 595, 600, while movement toward the first end 560 relaxes the springs 595, 600.

In use, the reciprocating pump 550 may be driven in a reciprocating motion within the bore 315. For example, the reciprocating pump 550 may move longitudinally along the pump axis 610 toward and away from the second end 565. As this movement occurs, the first section 570 may contact and rub against the inner surface of the bore 315 proximate to the first end. The first section 570 may also contact and rub against the O-ring 580. The second section 575 may contact and rub against the passageway 585 and/or the O-ring 590.

The second section 575 is positioned at least partially within the passageway 585 of the pump sleeve 555. Any portion of the second section 575 outside of the passageway 585 may be spaced apart from the surface of the bore 315 because of the smaller width of the second section 575 as compared to the maximum width of the bore 315.

The reciprocating pump 550 may be driven by the motor via the gear assembly 210. As the gear assembly 210 rotates, the reciprocating pump 550 moves along the pump axis 610. The first and second sections 570, 575 may each act as a piston for moving hydraulic fluid. Because the first and second sections 570, 575 are connected as one piece in the reciprocating pump 550, they may operate as series pistons. On an out stroke (e.g., when the reciprocating pump 550 is moving away from the second end 565 of the bore), a hydraulic fluid may enter the bore 315 and the passageway 585 from a reservoir (not shown). On an in stroke (e.g., when the reciprocating pump 550 moves toward the second end 565 of the bore 315), a hydraulic fluid may exit the bore 315 and the passageway 585 and move further along the tool 100. To push the fluid out of the bore 315 and/or the passageway 585, the force applied to the reciprocating pump 550 needs to exceed a spring force to compress the springs 595, 600.

During this movement, the smaller diameter second section 575 and the O-ring 590 may limit hydraulic fluid from passing between the bore 315 and the passageway 585 of the pump sleeve 555 along the outside of the second section 575. This may help to allow the first and second sections 570, 575 to operate as separate, in-series pistons and limit the first section 570 from driving hydraulic fluid into the passageway 585 instead of into the outlet.

As the reciprocating pump 550 moves, the outer surface of the first section 570 contacts the inner surface of the bore 315. The inner surface of the bore 315 and/or the outer surface of the first section 570 may be coated with a friction reducing material to reduce the frictional engagement between the two elements. Coating the outer surface of the first section 570 may also reduce friction between the first section 570 and the O-ring 590.

Like with the gear assembly 210, the coating used on the inner surface of the bore 315 and/or the outer surface of the first section 570 may be a DLC coating. This coating may reduce the abrasiveness of the aluminum material and limit scratching on the surface of the reciprocating pump 550. The DLC coating may also reduce the effects of radially directed forces on the reciprocating pump 550. For example, the DLC coating may further reduce the frictional effects caused when the reciprocating pump 550 is driven partly into the wall of the bore 315 and/or the O-ring by providing a smoother engagement and to allow the two surfaces to better slide past one another. The smoother engagement may improve efficiency.

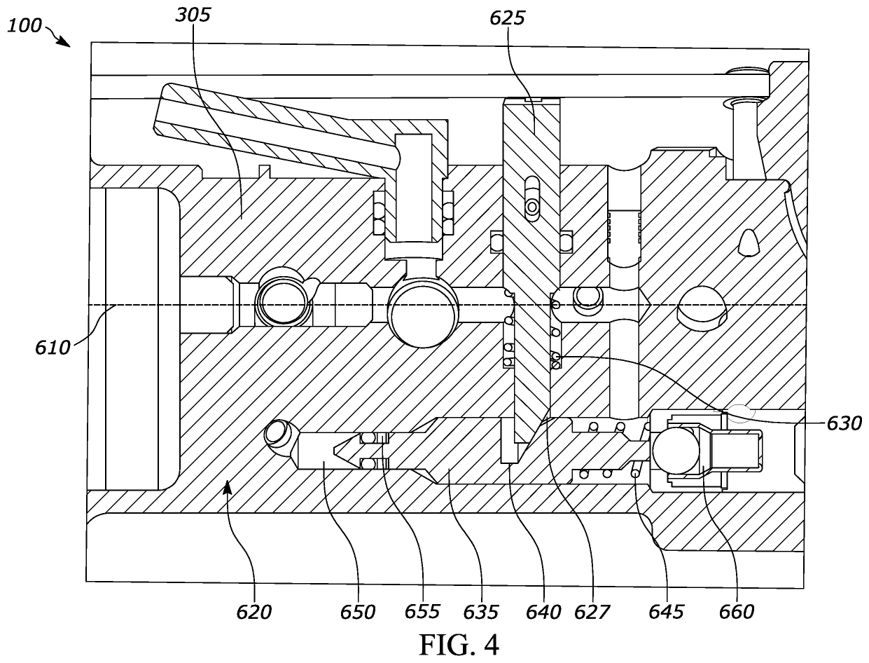

As shown in FIG. 4, the tool 100 may include a valve assembly 620, which may be disposed within the pump body 305. The valve assembly 620 may be used to permit and/or limit fluid flow in one or more directions within the tool 100. For example, the illustrated valve assembly 620 may be a drain for outputting fluid (e.g., hydraulic fluid) from the bore 315.

The illustrated valve assembly 620 includes a drain pin 625 that is at least partially received within the pump body 305. The drain pin 625 may be oriented substantially perpendicular from the pump axis 610, although other orientations may be used.

The drain pin 625 may be connected to a spring 630. The spring 630 may be positioned to bias the drain pin 625 against movement in at least one direction. For example, in the illustrated view of FIG. 4, the spring 630 biases the drain pin 625 in the vertically upward direction and opposes movement in the vertically downward direction.

The illustrated valve assembly 620 also includes a shuttle valve 635, which may also be at least partially disposed within the pump body 305. In the illustrated example, the shuttle valve 635 may be oriented substantially perpendicularly with respect to the drain pin 625. The shuttle valve 635 may include a groove 640 that is similarly shaped to an end 627 of the drain pin 625. For example, the groove 640 and the end 627 of the drain pin 625 may each include an inclined shape.

The shuttle valve 635 may be connected to a spring 645. The spring 645 may be positioned to bias the shuttle valve 635 against movement in at least one direction. For example, in the illustrated view of FIG. 4, the spring 645 biases the shuttle valve 635 toward the left and opposes movement toward the right.

In the neutral position, the shuttle valve 635 may be positioned so that the groove 640 is not aligned with the end 627 of the drain pin 625. For example, the end 627 may contact the inclined surface of the groove 640 and may not be seated entirely within the groove 640. The shuttle valve 635 may move out of the neutral position (e.g., to the right as illustrated in FIG. 4) to allow the drain pin 625 to be fully received within the groove 640. To move in this direction, the shuttle valve 635 may move against the bias of the spring 645.

A passageway 650 may extend in both directions from the shuttle valve 635. In the neutral position (e.g., the position illustrated in FIG. 4), the shuttle valve 635 may be seated against a surface 655 and may substantially limit fluid flow past the surface 655. A ball valve 660 may be disposed on an opposite end of the shuttle valve 635. In the neutral position, the shuttle valve 635 may be spaced apart from the ball valve 660, and the ball valve 660 may be seated to limit fluid flow in that direction. When the shuttle valve 635 moves against the bias of the spring 645 (e.g., to the right as illustrated in FIG. 4) so that the end 627 and the groove 640 are aligned, the shuttle valve 635 may also contact the ball valve 660 and move it to an open position so that fluid may pass through the ball valve 660.

As described above, the pump body 305 may be constructed from aluminum, which is both light and abrasive. The drain pin 625 and/or the shuttle valve 635 may be constructed from steel, although either could be constructed from other materials like titanium. Like the reciprocating pump 550, the drain pin 625 and/or the shuttle valve 635 move with a reciprocating motion along the surface of the pump body 305. To limit scratching, at least a portion of the surface (e.g., at least 25% of the surface is coated, at least 50% of the surface is coated, the entire surface is coated, etc.) of the drain pin 625 and/or the shuttle valve 635 may be coated with the DLC coating to reduce friction between the pump body 305 and the drain pin 625 and/or the shuttle valve 635. Further surfaces of the pump body 305 (e.g., the passageway 650) may also be coated with the DLC coating to further reduce abrasiveness and limit scratching on the surface of the drain pin 625 and/or shuttle valve 635.

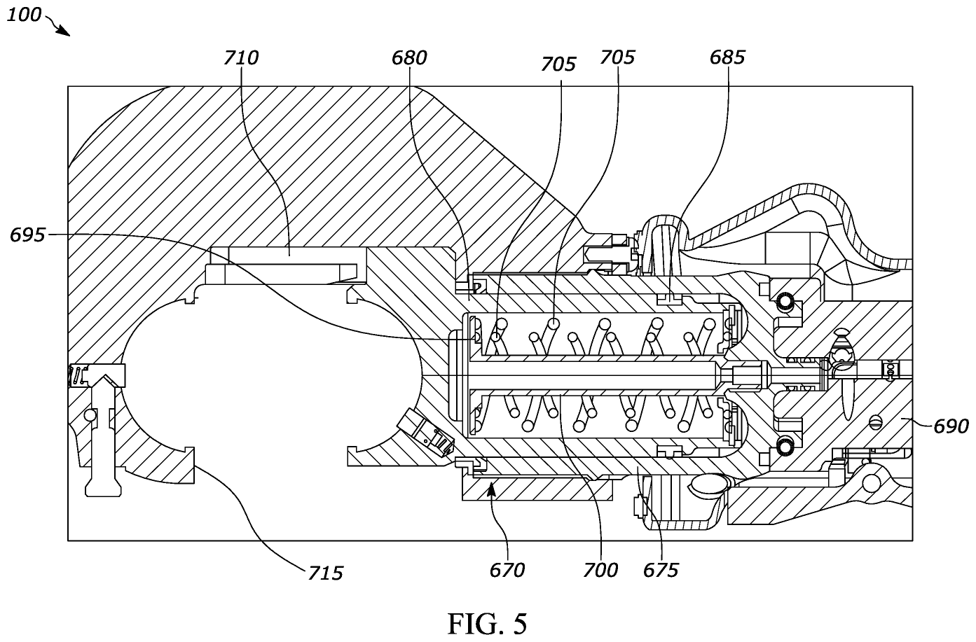

As shown in FIG. 5, the tool 100 may include a piston and cylinder assembly 670, which may be located proximate to the working portion 140 of the tool 100. The illustrated piston and cylinder assembly 670 includes a cylinder 675 and a piston 680 received at least partially within the cylinder 675. Both the cylinder 675 and the piston 680 may be constructed from steel, although other materials may also be used.

The inner diameter of the cylinder 675 may be substantially similar to the outer diameter of the piston 680. Therefore, at least part of the piston 680 may rub against the cylinder 675 during operation of the tool 100.

At least a portion of the piston 680 may be spaced apart from the inner surface of the cylinder 675. A seal 685 may be disposed within that space. The seal may limit the flow of fluid (e.g., hydraulic fluid) from flowing between the outer surface of the piston 680 and the inner surface of the cylinder 675. In the illustrated example, the seal 685 may include a T-shape, although in other examples, the seal 685 may be an O-ring or may have any other shape.

In the illustrated example, the piston and cylinder assembly 670 is connected to a rotating pump attachment 690, which may be used to drive the relative movement of the piston 680 relative to the cylinder 675. The rotating pump attachment 690 is connected to an oil tube 695 that is positioned within the piston 680. The oil tube 695 includes a central passage 700 that is fluidly connected to the rotating pump attachment 690. Within the piston 680, one or more springs 705 (e.g., two illustrated) may be connected between the piston 680 and the oil tube 695.

In use, the rotating pump attachment 690 may pump a hydraulic fluid into the oil tube 695. The oil tube 690 may be open at the end and may allow fluid to flow into the piston 680. As more fluid enters the piston 680, the fluid may push the piston 680 at least partially out of the cylinder 675 and against the bias of the springs 705. The piston 680 may also be open at the bottom (e.g., proximate to the rotating pump attachment 690) and the hydraulic fluid may exit the piston 680 into the cylinder 675. The seal 685 may limit or prevent the fluid from exiting the cylinder 675. The valve assembly 620 may be used to drain hydraulic fluid from the cylinder 675 as the piston 680 returns to an initial position.

In the illustrated example, the piston 680 may travel along a track 710 as it moves out of the cylinder 675. The piston 680 may move toward a fixed surface 715 that may limit further translational motion relative to the cylinder 675.

To limit scratching as this movement occurs, the outer surface of the piston 680 and/or the inner surface of the cylinder 675 may be coated with a material that reduces friction, like the DLC coating described above. The application of the coating may reduce leaks that occur as a result of scratching, thus extending the life of the tool 100.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A reciprocating assembly for driving a working portion of a tool, the reciprocating assembly comprising:
a body having a bore configured to contain a hydraulic fluid; and
a piston received within the bore and configured to move within the bore in a reciprocating motion between an extended position and a retracted position, wherein displacement of the piston within the bore is configured to cause displacement of hydraulic fluid when hydraulic fluid is in the bore;
wherein an outer surface of the piston and/or an inner surface of the bore at least partially coated with a friction reducing material.

2. The reciprocating assembly of claim 1, wherein the friction reducing material is a diamond like carbon (DLC) coating.

3. The reciprocating assembly of claim 1, wherein the bore is constructed from aluminum and the piston is constructed from steel, the DLC coating configured to reduce abrasiveness between the aluminum and the steel.

4. The reciprocating assembly of claim 1, further comprising a pump sleeve received within the bore and including a passageway, wherein the piston is at least partially received within the passageway and is configured to move within the passageway in the reciprocating motion between the extended position and the retracted position.

5. The reciprocating assembly of claim 4, wherein an inner surface of the passageway is at least partially coated with the friction reducing material.

6. The reciprocating assembly of claim 4, wherein the piston includes a first diameter and a second diameter that is smaller than the first diameter, the second diameter sized to be inserted into the passageway.

7. The reciprocating assembly of claim 1, further comprising a valve assembly fluidly connected to the bore, wherein the valve assembly is configured to drain the displaced hydraulic fluid from the bore.

8. The reciprocating assembly of claim 7, wherein the valve assembly comprises a valve configured to move within the body, the valve at least partially coated with the friction reducing material.

9. The reciprocating assembly of claim 1, wherein the body is connected to a pump attachment and an oil tube is positioned within the piston and in fluid connection with the pump attachment.

10. The reciprocating assembly of claim 9, further comprising a seal disposed between the bore and the piston, wherein the seal is configured to limit hydraulic fluid from exiting the bore after entering the bore from the piston.

11. A gear assembly for driving a working portion of a tool, the gear assembly comprising:
a stationary ring gear;
a central gear disposed within the inner diameter of the ring gear;
at least one planet gear contacting both the ring gear and the central gear; and
wherein at least one of the ring gear, the central gear, and the at least planet gear is at least partially coated with a friction reducing material.

12. The gear assembly of claim 11, wherein the friction reducing material is a diamond like carbon (DLC) coating.

13. The gear assembly of claim 11, wherein the gear assembly is a multi-stage gear assembly and the central gear is a sun gear.

14. The gear assembly of claim 13, wherein a carrier shaft is connected to the least one planet gear, the outer surface of the carrier shaft and/or an inner surface of the planet gear is at least partially coated with the friction reducing material.

15. The gear assembly of claim 11, wherein the gear assembly is a single stage gear assembly and the central gear is a pinion gear.

16. A tool comprising:
a gear assembly comprising an input gear and an output gear, wherein at least one of the input gear and the output gear are at least partially coated with a friction reducing material; a reciprocating assembly configured to be driven by the gear assembly, the reciprocating assembly comprising:
a body having a bore configured to contain a hydraulic fluid; and
a piston received within the bore and configured to move within the bore in a reciprocating motion between an extended position and a retracted position, wherein displacement of the piston within the bore is configured to cause displacement of hydraulic fluid when hydraulic fluid is in the bore;
wherein an outer surface of the piston and/or an inner surface of the bore at least partially coated with a friction reducing material; and
a working portion configured to be driven by the reciprocating assembly.

17. The tool of claim 16, wherein the friction reducing material is a diamond like carbon (DLC) coating.

18. The tool of claim 16, further comprising a pump sleeve received within the bore and including a passageway, wherein the piston is at least partially received within the passageway and is configured to move within the passageway in the reciprocating motion between the extended position and the retracted position.

19. The tool of claim 16, wherein the input gear is a sun gear and the output gear is a planet gear, the gear assembly further comprises a stationary ring gear, the sun gear is disposed within the inner diameter of the ring gear, and the planet gear is in contact with both the ring gear and the sun gear.

20. The tool of claim 16, further comprising a valve assembly fluidly connected to the bore, wherein the valve assembly is configured to drain the displaced hydraulic fluid from the bore.
